(19) United States
(12) Patent Application Publication
(10) Pub. No.: US 2022/0087263 A1
(43) Pub. Date: Mar. 24, 2022

(54) HERBICIDE COMPOSITION AND APPLICATION THEREOF

(71) Applicant: SHENYANG SINOCHEM AGROCHEMICALS R&D CO., LTD., Shenyang, Liaoning (CN)

(72) Inventors: Dongliang CUI, Shenyang, Liaoning (CN); Hongjuan MA, Shenyang, Liaoning (CN); Jichun YANG, Shenyang, Liaoning (CN); Aiying GUAN, Shenyang, Liaoning (CN); Changling LIU, Shenyang, Liaoning (CN); Yanmei LUO, Shenyang, Liaoning (CN); Zhengmao LU, Shenyang, Liaoning (CN)

(21) Appl. No.: 17/413,933

(22) PCT Filed: Nov. 21, 2019
(86) PCT No.: PCT/CN2019/119984

§ 371 Date: Jun. 14, 2021

(30) Foreign Application Priority Data
Dec. 14, 2018 (CN) 201811535534.9

(51) Int. Cl. A01N 43/80; A01P 13/00; A01N 43/90

(52) U.S. Cl. CPC A01N 43/80; A01N 43/90; A01P 13/00

(57) ABSTRACT

The present invention relates to a herbicidal composition and an application method thereof. The composition comprises two active components of A and B, wherein the component A is selected from a compound shown in the following general formula:

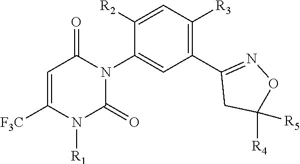

The component B is selected from one of ACCase inhibitor herbicides. The herbicidal composition of the present invention is especially suitable for controlling weeds which are tolerant or resistance to organophosphorus herbicides, especially glyphosate.

### TECHNICAL FIELD

The present invention belongs to the field of agricultural herbicides, and relates to a herbicidal composition and an application thereof.

### BACKGROUND

Patent WO2016095768 has reported an isoxazoline-containing uracil compound shown in a general formula I:

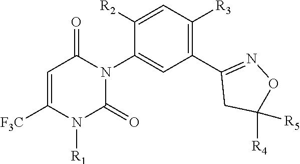

The compound in the general formula I has good herbicidal activity, can effectively control weeds of different leaf stages, such as barnyard grass, Cyperus difformis, Juncellus serotinus, crab grass, hispid arthraxon, piemarker, zinnia, Amaranthus retroflexus, purslane, xanthium, nightshade, cassia, Hibiscus trionum and Glycine ussuriensis, and can obtain good weeding effect at low dose.

Diquat is a contact non-selective herbicide and its drugs can be quickly absorbed by green plant issues and are highly destructive to the lipid synthesis of plants and the bilayer membranes of chloroplasts to stop photosynthesis and make the plants lose water rapidly, wither and die. After contact with soil, the plants quickly loss activity. The diquat is widely used for weeding control quickly in crop fields, orchards, no-til field, and before harvesting. However, the herbicide has poor conduction, can only damage the contact sites with the herbicide and cannot kill the root systems of the weeds.

### SUMMARY

The purpose of the present invention is to provide a herbicidal composition and an application thereof.

To achieve the above purpose, the present invention adopts the following technical solution:

A herbicidal composition is provided. Active components of the herbicidal composition are composed of component A and component B; the component A is a compound shown in the following structural formula I; the component B is diquat; a weight ratio of the active component A to the active component B is 1:40 to 40:1;

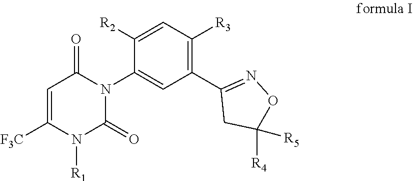

in the formula:

R₁ is selected from methyl;

R₂ and R₃ can be identical or different, and are respectively selected from hydrogen, fluorine or chlorine;

R₄ is selected from CO₂R₆;

R₅ is selected from hydrogen, methyl, ethyl, tert-butyl or trifluoromethyl;

R₆ is selected from hydrogen, methyl, ethyl, n-propyl, n-butyl, isopropyl, isobutyl, tert-butyl, trifluoroethyl, allyl, propargyl, methoxyethyl, ethoxyethyl, 2-tetrahydrofuran methylene or 3-tetrahydrofuran methylene.

Preferably, the weight ratio of the component A to the component B in the composition is 1:20 to 20:1;

for the component A, in the formula I:

R₁ is selected from methyl;

R₂ is selected from fluorine;

R₃ is selected from chlorine;

R₄ is selected from CO₂R₆;

R₅ is selected from methyl;

R₆ is selected from hydrogen, methyl, ethyl, n-propyl, n-butyl, isopropyl, isobutyl, tert-butyl, trifluoroethyl, allyl, propargyl, methoxyethyl, ethoxyethyl, 2-tetrahydrofuran methylene or 3-tetrahydrofuran methylene;

the component B is diquat.

More preferably, the weight ratio of the component A to the component B in the composition is 1:10 to 10:1;

for the component A, in the formula I:

R₁ is selected from methyl;

R₂ is selected from fluorine;

R₃ is selected from chlorine;

R₄ is selected from CO₂C₂H₅, CO₂C₃H₇ or CO₂C₄H₉;

R₅ is selected from methyl;

the component B is diquat.

An application of the herbicidal composition is provided. An application of the composition in management of weeds is provided.

The weeds are grass weeds, broadleaf weeds, sedge weeds, algae, ferns and woody shrubs.

A herbicide is provided; a herbicidal active component is the herbicidal composition, and the weight percentage of the herbicidal composition is 0.1-95%.

In the definitions of the compounds of the general formula I provided above, the terms used in the collection are generally defined as follows:

Halogen: fluorine, chlorine, bromine or iodine. Alkyl: linear or branched alkyl, such as methyl, ethyl, propyl, isopropyl, n-butyl or tert-butyl. Haloalkyl: linear or branched alkyl on which hydrogen atoms can be partially or fully replaced by halogen atoms, such as chloromethyl, dichloromethyl, trichloromethyl, fluoromethyl, difluoromethyl and trifluoromethyl.

Part of compounds in the general formula I can be illustrated by specific compounds listed in Table 1, but the present invention is not limited to the compounds. The compounds in the general formula can be prepared as recorded in WO2016095768. In the table, the compound R₁=CH₃, and other groups are shown in Table 1.

TABLE 1
formula I

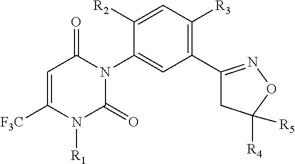

| No. | R₂ | R₃ | R₄ | R₅ |
|---|---|---|---|---|
| A-1 | F | Cl | CO₂H | CH₃ |
| A-2 | F | Cl | CO₂CH₃ | CH₃ |
| A-3 | F | Cl | CO₂C₂H₅ | CH₃ |
| A-4 | F | Cl | CO₂C₃H₇ | CH₃ |
| A-5 | F | Cl | CO₂C₄H₉ | CH₃ |
| A-6 | F | Cl | CO₂(cyclo-C₃H₅) | CH₃ |
| A-7 | F | Cl | CO₂(iso-C₃H₇) | CH₃ |
| A-8 | F | Cl | CO₂(tert-C₄H₉) | CH₃ |
| A-9 | F | Cl | CO₂CH₂C≡CH | CH₃ |
| A-10 | F | Cl | CO₂CH₂CH═CH₂ | CH₃ |
| A-11 | F | Cl | CO₂CH₂C(CH₃)═CH₂ | CH₃ |
| A-12 | F | Cl | CO₂CH₂CH₂OC₂H₅ | CH₃ |
| A-13 | F | Cl | CO₂CH₂CH₂OCH₃ | CH₃ |
| A-14 | F | Cl | CO₂CH₂CH₂OCOCH₃ | CH₃ |
| A-15 | F | Cl | CO₂CH₂Ph | CH₃ |
| A-16 | F | Cl | CO₂CH₂(4-Cl—Ph) | CH₃ |
| A-17 | F | Cl | CO₂CH₂(2,6-2F—Ph) | CH₃ |
| A-18 | F | Cl | CO₂CH₂(2,6-2Cl—Ph) | CH₃ |
| A-19 | F | Cl | CN | CH₃ |
| A-20 | F | Cl | CH₂OCOCH₃ | CH₃ |
| A-21 | F | Cl | CO₂CH₂CF₃ | CH₃ |
| A-22 | F | Cl | CO₂CH₂CH(CH₃)₂ | CH₃ |
| A-23 | F | Cl | 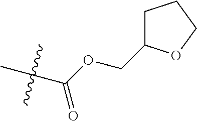 [SMILES: *C(=O)OCC1CCCO1] | CH₃ |
| A-24 | F | Cl | CO₂CH₃ | H |
| A-25 | F | Cl | CO₂C₂H₅ | H |
| A-26 | F | Cl | CO₂C₃H₇ | H |
| A-27 | F | Cl | CO₂C₄H₉ | H |
| A-28 | F | Cl | CO₂(cyclo-C₃H₅) | H |
| A-29 | F | Cl | CO₂(iso-C₃H₇) | H |
| A-30 | F | Cl | CO₂(tert-C₄H₉) | H |
| A-31 | F | Cl | CO₂CH₂CH₂OC₂H₅ | H |
| A-32 | F | Cl | CO₂CH₂CH₂OCH₃ | H |
| A-33 | F | Cl | CO₂CH₂CH₂OCOCH₃ | H |
| A-34 | F | Cl | CO₂CH₂Ph | H |
| A-35 | F | Cl | CO₂CH₂(4-Cl—Ph) | H |
| A-36 | F | Cl | CO₂CH₂(2,6-2F—Ph) | H |
| A-37 | F | Cl | CO₂CH₂(2,6-2Cl—Ph) | H |
| A-38 | H | Cl | CO₂H | CH₃ |
| A-39 | H | Cl | CO₂CH₃ | CH₃ |
| A-40 | H | Cl | CO₂C₂H₅ | CH₃ |
| A-41 | H | Cl | CO₂C₃H₇ | CH₃ |
| A-42 | H | Cl | CO₂C₄H₉ | CH₃ |
| A-43 | H | Cl | CO₂(cyclo-C₃H₅) | CH₃ |
| A-44 | H | Cl | CO₂(iso-C₃H₇) | CH₃ |
| A-45 | H | Cl | CO₂(tert-C₄H₉) | CH₃ |

The herbicidal composition of the present invention is applied to places where undesired vegetation is present or expected to be present, i.e., selectively or non-selectively used in places where undesired vegetation is present or expected to be present. Specifically, the herbicidal composition can be applied to stems and leaves of undesired vegetation, or moorburn before planting or before seedling emergence and after planting, and post-emergence treatment of tolerant crops and non-tolerant crops.

The herbicide is applied to bare places, orchards, rubber plantations, idle arable land, rubber plantations, eucalyptus forests, cedar forests, forests, firebreaks, lawns, railways, highways, airports and warehouses.

The tolerant crops and the non-tolerant crops are selected from rice, corn, bean crops, oilseed rapes, vegetables, cotton, beets, small grains, soybeans, peanuts, sugar cane, sunflower, rear plants and woody plants. The orchards comprise apple orchards, peach orchards, vineyards, pear orchards, tea orchards, mulberry orchards and citrus orchards. The undesired vegetation comprises grass weeds, broadleaf weeds, sedge weeds, algae, ferns and woody shrubs.

The present invention has the following advantages:

1. The herbicidal composition of the present invention has a very obvious synergy between the two active components, thereby reducing the dosages of the active components.

2. The herbicidal composition of the present invention jointly uses the two active components, thereby expanding the weed control spectrum, reducing the dosages and use frequency, preventing resistant weeds from developing resistance, and controlling the resistant weeds.

3. The herbicidal composition of the present invention uses the complementation of different action mechanisms and has the characteristics of contact and conduction, thereby increasing the adaptability to adverse environments such as drought and low temperature, accelerating the response speed and more weeding control thoroughly.

4. The herbicidal composition of the present invention extends the suitable application stage, further enhances the continuous inhibition and control effects on the grass weeds with larger leaf stage. and also has high control effect on some glyphosate-resistant weeds such as Conyza canadensis (L.) Cronq., Cynodon dactylon (Linn.) Pers. and Eleusine indica (L.) Gaertn.

5. The herbicide of the present invention can be used as pre-emergence and post-emergence herbicide to control most of weeds in bare places, orchards, idle arable land, rubber plantations, eucalyptus forests, forests, firebreaks, lawns, railways, highways, airports and warehouses.

### DETAILED DESCRIPTION

The synergy of the herbicidal composition of the present invention for the grass weeds and the broadleaf weeds can be further illustrated through the following embodiments, but the present invention is not limited to this. Active components of the herbicidal composition of the present invention are composed of component A and component B; the component A is a compound shown in formula I; and the component B is diquat. The percentages in all proportions are weight percentages, and the active components are computed by effective contents.

### Embodiment of Determination of Biological Activity

Embodiment 1 The synergistic effects of the compound contained with component A and component B is conducted in greenhouse in the present invention, and the component A takes A-3, A-4 and A-5 compounds in the compound table 1 of the general formula I as examples.

The synergistic effects of the composition on the weeds is defined through greenhouse test.

A weed culture method is: respectively planting weed seeds of piemarker and barnyard grass quantitatively in a paper cup with a diameter of 7 cm and containing nutrient soil; after planting, covering soil, pressing and watering; and then culturing in a greenhouse. The grass weeds grow to 5-7 leaf stages; the broadleaf weeds grow to 6-8 leaf stages; pre-emergence and post-emergence treatment are conducted with three times repeats. The weeds are placed in the greenhouse after treatment when the leaf without water dried naturally in air, and cultured with normal method. According to the inhibited condition or dying condition of the weeds, after treatment 30 days, visual inspection of the control effect is conducted (see Table 2-Table 7).

A herbicide formulation preparing method: all test samples are technical dissolved by a mixed solvent of acetone and dimethylformyl (1:2, V/V) firstly; then 1‰ of Tween 80 water is used to prepare mother liquor of a certain concentration; and then processing solutions of different doses are prepared according to test schemes.

The present invention adopts a Gowing method for evaluating the combined action of the proposed composition.

Theoretical Value

$${E}_{0} = X + Y - \frac{XY}{100}$$

In the formula:

X—the weed control effect when the dosage of the component A of the herbicide is P;

Y—the weed control effect when the dosage of the component B of the herbicide is Q;

E₀—the theoretical control effect when the dosage of the component A of the herbicide is P+the theoretical control effect when the dosage of the component B of the herbicide is Q;

E—the measured control effect after the component A of the herbicide and the component B of the herbicide are mixed in the above proportion.

When E−E₀>10%, the synergy is achieved; when E−E₀<−10%, antagonism is achieved; when the value of E−E₀ is between ±10%, the addition effect is achieved.

TABLE 2
Combined Action of Mixture of Components A-3 and B on Barnyard Grass and Piemarker

| | | Barnyard Grass | | | Piemarker | | |
|---|---|---|---|---|---|---|---|
| | Dose | Measured | Theoretical | | Measured | Theoretical | |
| Drug | (ga.i./hm²) | Value E | Value E₀ | E − E₀ | Value E | Value E₀ | E − E₀ |
| Component A | 7.5 | 20 | — | — | 15 | | |
| (List Compound | 30 | 35 | — | — | 45 | | |
| A-3) | 120 | 60 | — | — | 65 | | |
| Component B | 7.5 | 30 | — | — | 20 | | |
| (Diquat) | 30 | 50 | — | — | 50 | | |
| | 120 | 65 | — | — | 60 | | |
| List | 7.5 + 7.5 | 60 | 44.0 | 16.0 | 45 | 32.0 | 13.0 |
| Compound | 7.5 + 30 | 75 | 60.0 | 15.0 | 75 | 57.5 | 17.5 |
| A-3 + | 7.5 + 120 | 90 | 72.0 | 18.0 | 90 | 66.0 | 24.0 |
| Diquat | 30 + 7.5 | 75 | 54.5 | 20.5 | 75 | 56.0 | 19.0 |
| | 30 + 30 | 85 | 67.5 | 17.5 | 90 | 72.5 | 17.5 |
| | 30 + 120 | 90 | 77.3 | 12.8 | 95 | 78.0 | 17.0 |
| | 120 + 7.5 | 90 | 72.0 | 18.0 | 90 | 72.0 | 18.0 |
| | 120 + 30 | 95 | 80.0 | 15.0 | 100 | 82.5 | 17.5 |
| | 120 + 120 | 100 | 86.0 | 14.0 | 100 | 86.0 | 14.0 |

TABLE 3
Combined Action of Mixture of Components A-4 and B on Barnyard Grass and Piemarker

| | | Barnyard Grass | | | Piemarker | | |
|---|---|---|---|---|---|---|---|
| | Dose | Measured | Theoretical | | Measured | Theoretical | |
| Drug | (ga.i./hm²) | Value E | Value E₀ | E − E₀ | Value E | Value E₀ | E − E₀ |
| Component A | 7.5 | 15 | — | — | 25 | — | — |
| (List Compound | 30 | 40 | — | — | 40 | — | — |
| A-4) | 120 | 55 | — | — | 70 | — | — |
| Component B | 7.5 | 20 | — | — | 15 | — | — |
| (Diquat) | 30 | 45 | — | — | 55 | — | — |
| | 120 | 60 | — | — | 65 | — | — |
| List | 7.5 + 7.5 | 45 | 32.0 | 13.0 | 55 | 36.3 | 18.8 |
| Compound | 7.5 + 30 | 70 | 53.3 | 16.8 | 80 | 66.3 | 13.8 |
| A-4 + | 7.5 + 120 | 85 | 66.0 | 19.0 | 90 | 70.0 | 20.0 |
| Diquat | 30 + 7.5 | 70 | 52.0 | 18.0 | 65 | 49.0 | 16.0 |
| | 30 + 30 | 80 | 67.0 | 13.0 | 85 | 73.0 | 17.0 |
| | 30 + 120 | 98 | 76.0 | 22.0 | 98 | 76.0 | 22.0 |
| | 120 + 7.5 | 80 | 64.0 | 16.0 | 85 | 74.5 | 15.5 |
| | 120 + 30 | 90 | 75.3 | 14.8 | 100 | 86.5 | 13.5 |
| | 120 + 120 | 100 | 82.0 | 18.0 | 100 | 88.0 | 12.0 |

TABLE 4
Combined Action of Mixture of Components A-5 and B on Barnyard Grass and Piemarker

| | | Barnyard Grass | | | Piemarker | | |
|---|---|---|---|---|---|---|---|
| | Dose | Measured | Theoretical | | Measured | Theoretical | |
| Drug | (ga.i./hm²) | Value E | Value E₀ | E − E₀ | Value E | Value E₀ | E − E₀ |
| Component A | 7.5 | 25 | — | — | 35 | — | — |
| (List Compound | 30 | 35 | — | — | 45 | — | — |
| A-5) | 120 | 50 | — | — | 60 | — | — |
| Component B | 7.5 | 30 | — | — | 30 | — | — |
| (Diquat) | 30 | 40 | — | — | 45 | — | — |
| | 120 | 55 | — | — | 55 | — | — |
| List | 7.5 + 7.5 | 65 | 47.5 | 17.5 | 70 | 54.5 | 15.5 |
| Compound | 7.5 + 30 | 75 | 55.0 | 20.0 | 75 | 64.3 | 15.8 |
| A-5 + | 7.5 + 120 | 80 | 66.3 | 13.8 | 85 | 70.8 | 19.3 |
| Diquat | 30 + 7.5 | 65 | 54.5 | 15.5 | 75 | 61.5 | 13.5 |
| | 30 + 30 | 85 | 61.0 | 24.0 | 90 | 69.8 | 20.3 |
| | 30 + 120 | 85 | 70.8 | 14.3 | 90 | 75.3 | 14.8 |
| | 120 + 7.5 | 90 | 65.0 | 25.0 | 90 | 72.0 | 18.0 |
| | 120 + 30 | 90 | 70.0 | 20.0 | 95 | 78.0 | 17.0 |
| | 120 + 120 | 95 | 77.5 | 17.5 | 98 | 82.0 | 16.0 |

Test results (Table 2, Table 3 and Table 4) indicate that, obvious synergies are presented on the barnyard grass and the piemarker when the components A-3, A-4 and A-5 are respectively mixed with the component B.

1. A herbicidal composition, characterized in that active components of the herbicidal composition are composed of component A and component B; the component A is a compound shown in the following structural formula I; the component B is diquat; a weight ratio of the active component A to the active component B is 1:40 to 40:1; 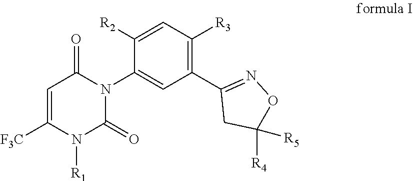
in the formula:
R₁ is selected from methyl;
R₂ and R₃ can be identical or different, and are respectively selected from hydrogen, fluorine or chlorine;
R₄ is selected from CO₂R₆;
R₅ is selected from hydrogen, methyl, ethyl, tert-butyl or trifluoromethyl;
R₆ is selected from hydrogen, methyl, ethyl, n-propyl, n-butyl, isopropyl, isobutyl, tert-butyl, trifluoroethyl, allyl, propargyl, methoxyethyl, ethoxyethyl, 2-tetrahydrofuran methylene or 3-tetrahydrofuran methylene.

2. The herbicidal composition according to claim 1, characterized in that the weight ratio of the component A to the component B in the composition is 1:20 to 20:1;
for the component A, in the formula I:
R₁ is selected from methyl;
R₂ is selected from fluorine;
R₃ is selected from chlorine;
R₄ is selected from CO₂R₆;
R₅ is selected from methyl;
R₆ is selected from hydrogen, methyl, ethyl, n-propyl, n-butyl, isopropyl, isobutyl, tert-butyl, trifluoroethyl, allyl, propargyl, methoxyethyl, ethoxyethyl, 2-tetrahydrofuran methylene or 3-tetrahydrofuran methylene;
the component B is diquat.

3. The herbicidal composition according to claim 2, characterized in that the weight ratio of the component A to the component B in the composition is 1:10 to 10:1;
for the component A, in the formula I:
R₁ is selected from methyl;
R₂ is selected from fluorine;
R₃ is selected from chlorine;
R₄ is selected from CO₂C₂H₅, CO₂C₃H₇ or CO₂C₄H₉;
R₅ is selected from methyl;
the component B is diquat.

4. An application of the herbicidal composition of claim 1, characterized in an application of the composition in management of weeds.

5. The application of the herbicidal composition according to claim 4, characterized in that the weeds are grass weeds, broadleaf weeds, sedge weeds, algae, ferns and woody shrubs.

6. A herbicide, characterized in that a herbicidal active component is the herbicidal composition of claim 1, and the weight percentage of the herbicidal composition is 0.1-95%.
